(19) United States
(12) Patent Application Publication
(10) Pub. No.: US 2002/0066040 A1
(43) Pub. Date: May 30, 2002

(54) Secure computerized network access system and method

(76) Inventor: Roman Rozenberg, Forest Hills, NY (US)

Correspondence Address: MALLOY & MALLOY, P.A., 2800 S.W. Third Avenue, Historic Coral Way, Miami, FL, 33129, US

(21) Appl. No.: 09/727,304

(22) Filed: Nov. 30, 2000

(51) Int. Cl. H04L 9/32

(52) U.S. Cl. 713/202

(57) ABSTRACT

A secure computerized network access system including a plurality of local computer processor assemblies communicatively associated with a network server. The network server includes a network access control assembly associated therewith and structured to restrict access to the network server from a user utilizing a local computer processor assembly by requiring a personal access code before permitting access to the user. A biometric input assembly is further provided and is structured to receive a biometric identifier from the user and provide that biometric identifier to a biometric authentication assembly that compares it with a plurality of biometric authentication templates. The biometric authentication assembly is further structured to identify the user as an authorized user upon the biometric identifier corresponding a biometric authentication template, and to provide the personal access code for the authorized user to the network access control assembly.

### BACKGROUND OF THE INVENTION

1. Field of the Invention

The present invention relates to a secure computerized network access system and method wherein enhanced biometric security is seamlessly integrated with an existing network access system of the type which usually includes a sign on restriction in the form of a user identification and user to find the password. The system and method are configured to substantially enhance the security that can be achieved utilizing normal network access control without requiring the installation of a completely new network management system and/or network access system, but rather in a manner which utilizes biometrics to substantially enhance the security that can be achieved utilizing the already in place security systems and protocols.

2. Description of the Related Art

The utilization of global and/or local computerized networks is becoming more and more common in a large number in variety of personal and business endeavors. Naturally, however, user access to such systems, and in particular to system resources, is not unlimited. For example, merchants and/or service providers often restrict use of their system resources to only certain individuals and/or verified account holders, and individual users frequently seek to maintain a degree of privacy and control over their information and accounts. Furthermore, as more and more sensitive and/or valuable information is being maintained on computerized systems, security protocols and procedures are becoming increasingly important to ensure that only authorized users are allowed access to the restricted system resources, including files and/or programs.

As a result of the important security needs associated with computerized networks, network access and/or operating systems are generally provided with some security protocols so as to restrict access to certain system resources. In almost all instances, such security protocols involve a user identification, such as the unique user name or account number to identify a user, followed by the entry of an appropriate password associated with that user and/or account. Such a user password can vary in length from a very small number of alpha numeric characters to a very large number of alpha numeric characters, depending upon the degree of security and/or the capacity of the system. Although it is recognized that the larger the number of characters associated with a security password, the more secure the system is and the more difficult it would be for another to steal and or otherwise determined the password, in most systems, password lengths are limited to only a few characters. A primary reason for the relatively small number of characters for access passwords relates to the fact that the password is intended to be remembered and/or memorized by a users. In particular, for obvious security reasons, it is preferred that a user generally not write down their password in an accessible location for fear that an unauthorized user will some how obtain and/or steal a copy of that password. As such, passwords are generally intended to be defined by a series of alpha numeric characters which are either familiar to and/or can be memorized by the individual users. For this reason, a substantially long password, although increasing security, would also become very difficult and often un-practical to utilize in a variety of network access situation. Accordingly, it would be beneficial to provide a secure computerized network access system which is capable of substantially enhancing the security capabilities and parameters of existing network operating systems and access protocol without requiring a user to remember and/or memorize long, complicated password so as to maximize security.

It is also noted that in resent years substantial advances have been made in the area of biometrics, including specifically finger printing analysis, retinal scanning, etc. Such systems are typically utilized for very high security access restriction in order to effectively determined that the identity of the user wishing access to restrict system is an unauthorized user. While such systems do provide a substantial degree of accuracy and security, they can often be impractical for utilization in connection with computerized network access systems, and in particular with computerized networks that are already in place and already have pre-existing network operating systems and access controls.

Specifically, although some computerized networks are still being set up such that some form of biometrics can be integrated at the initial stages, it more common that the computerized networks have already been pre-establish and are already widely in use in a variety of fields and circumstances. Significantly, such existing network operating systems do much more than restrict access to the network, files and/or programs. Moreover, such existing network operating systems can be very expensive to initially purchase and install in a manner that is effective and optimized for the particular user. As a result, it would be substantially in-efficient and cost prohibitive to completely remove or change the existing network operating system merely so as to introduced a biometric operating system of the type currently available. Furthermore, it is also generally not possible and/or practical to interchange modules or components of existing networks with modules and/or components of other system. As a result, it would be highly beneficial to provide a computerized network access system which can effectively and efficiently integrate biometric utilization with an existing computerized network access system seamlessly and in a manner which does not require any significant and/or substantial modification and/or alteration of the existing network operating system and its security protocols. Such a system and/or method should compliment and enhance the existing network operating system rather than modify and/or alter its mode of operation, thereby maintaining system resources intact and indeed allowing for partial installation in connection with only a portion of the network system resources rather than across the board installation.

### SUMMARY OF THE INVENTION

The present invention relates to a secure computerized network access system and method. In particular, the secure computerized network access system includes at least one local computer processor assembly, typically whereby a user will gain access to a computerized network. Along these lines, the computerized network access system will preferably include at least one network server communicatively associated with the computer processor assembly. The network server is provided so as to allow access by the local computer processor assembly to network resources, including server functionality, applications, files, access to other local computer processor assemblies, systems and/or equipment, etc.

The secure computerized network access system further includes a network access control assembly. The network access control assembly is structure to require a personal access code in order to permit access by the user to the network server. Typically, but not necessarily, this network access control assembly is a conventional password based network access control assembly typically associated with the computerized network and/or its operating system.

The present invention further includes a biometric input assembly. Specifically, the biometric input assembly is structured to obtain a biometric identifier from a user that is seeking to gain access to the computerized network. A biometric authentication assembly is provided in association with the biometric input assembly so as to compare the biometric identifier of the user with at least one biometric authentication template. At least as a result of this comparison, the biometric authentication assembly may be further structured to identify the user as an authorized user, preferably upon the biometric identifier corresponding the biometric authentication template.

The biometric authentication assembly is further structured to provide the personal access code associated with the authorized user to the network access control assembly. As a result, the personal access code can be substantially long to provide for substantially enhanced and increased security without requiring the authorized user to personally remember and/or memorize the personal access code. Furthermore, access can be gained in a much quicker and easier manner than requiring user input of a password, and in a manner which substantially secures the personal access code and prevented facilitated theft and/or copy.

Preferably utilizing the previously defined system, the present invention further relates to a method of gaining access to restricted system resources over a computerized network. In particular, the method includes the initial step of obtaining a biometric identifier from a user seeking access to the restricted system resources. The biometric identifier is then compared with at least part of at least one biometric authentication template in order to identify the user as an authorized user if a corresponding match occurs. A personal identification code for the authorized user is then identified, preferably by the previously mentioned biometric authentication assembly. Finally, the personalized identification code for the authorized user is provided to a network access control assembly for conventional processing by the network access control assembly in order to permit access to the computerized network, such as to the restricted system resources.

These and other features and advantages of the present invention will become more clear when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of one embodiment of the secure computerized network access system of the present invention wherein the authentication server is isolated from the network server;

FIG. 2 is a schematic representation of another embodiment of secure computerized network access system of the present invention wherein the network server and authentication server are integral with one another.

Like reference numerals refer to like parts throughout the several views of the drawings.

### DETAILED DESCRIPTION OF THE PREFERRED EMBODIMENT

Shown throughout the Figures, the present invention is directed to a secure computerized network access system and method of obtaining access to restricted system resources, generally indicated as 10. The computerized network access system 10 is structured for use independently and/or as part of any of a variety of computerized networks, be it a local, network, a dedicated computer network, and/or a global or remote computerized network. Furthermore, the computerized network can be a multi function network having a large variety of functionality, data entry and file management capabilities, and/or can be a more specified or dedicated network, such as may be utilized in association with banking, purchasing, etc. Further, within the context of the present invention, the computerized network may include only one or a large number of computer processor assemblies.

In particular, as illustrated in Figures, the present invention includes at least one local computer processor assembly 30, but in most instances will include a plurality of local computer processor assemblies 30, 30′ as is more typical in a computerized network. Along these lines, at least one network server 20 is also preferably provided and is communicatively associated with the one or more local computer processor assembly 30. In this regard, it is recognized that one local computer processor may be a fully functional personal computer and/or network terminal type computer processor assembly, or may merely be an access terminal/processor with very limited functionality only associated with gaining access to the network. Moreover, although the network server 20 and the local computer processor 30 are generally remote from one another and connected via conventional cabled and/or wireless means, it is also understood that within the contest of the present invention the network server 20 and local computer processor assembly 30 may comprise a single personal computer or main frame wherein access thereto is restricted and/or access to select portion or partitions thereof is restricted. It is understood, that in either instance access is being sought to restricted system resources such as those contained on the network server 20 and/or other computer processor assembly(s) connected to and/or associated with the network server 20 or accessible via the network server 20.

The present invention further includes a network access control assembly 25. The network access control assembly 25 is structured to restrict access to system resources such as the network server 20 itself, and/or files, applications, etc. which are on or accessible by the network server 20 in some fashion. The network access control assembly 25 preferably includes or is associated with a traditional network operating system wherein password based access control is provided so that one. and more commonly a plurality of users may gain permitted and secure access to restricted system resources utilizing the local computer processor assembly 30. Along these lines the network access control assembly 25 is structure to require a personal access code so as to permit access by the user to the network server 20. The personal access code may include any combination and/or length of alpha numeric characters or other symbols or characters to be provided in association with the particular users such that the user may gain the desired access to the restricted system resources. With regard to the network access control assembly 25, it is understood that a variety of dedicated and/or commercially available network operating systems can be effectively integrated into the present invention, an object of the present invention being the versatility thereof for integration with any pre-existing or to be installed network operating system and network access control assembly 25 of the traditional type which requires a personal access code to permit user access. Furthermore, as will be described, this integration takes place in a manner that does not hinder or otherwise affect the normal operation of the network operating system beyond making it easier and more secure for its users.

The present secure computerized network access system 10 further includes a biometric access system. The biometric access system is structure to preferably work in association with the network access control assembly so as to facilitate much more secure and facilitated user accessability to the network server and the restricted system resources. In particular, the biometric access system includes at least one, but generally a plurality of biometric input assemblies 35. In particular, the biometric input assembly 35 is structured to receive a biometric identifier from the user and although it may be a stand alone and/or separate unit is preferably integrated with and/or at least associated with a particular local computer processor assembly 30 by which a user desires to gain access. Along these lines, it is recognized that a completely isolated biometric input assembly 35 may be provided, mere identification of a terminal or local computer processor assembly 30 at which the use will gain immediate access, such as within a defined time period being possible if the illustrated preferred integration directly with a local computer processor assembly 30 is not desired. Additionally, and as illustrated in the Figures, it is recognized that some local computer processor assemblies 30′ may not include the biometric input assembly 35 associated therewith. Specifically, it is understood that within the confines of the present invention, a partial installation of the biometric access system in association with one or some local computer processor assemblies 30 may be achieved. Such a partial installation is beneficial in situations when high security is needed only to gain access to certain restricted system resources at a higher security level and the system resources which most network users require can be accessed in a normal fashion from any local computer processor assembly 30′. For example, it is understood that certain restricted system resources may be segregated by a very high degree of security accessible only by certain limited individual. As a result, only one or a limited number of local computer processor assemblies 30 may need to be capable of accessing those restricted system resources. Accordingly, only those terminals would be the only ones requiring the biometric input assembly 35 in association therewith.

As indicated the biometric input assembly 35 is structured to receive a biometric identifier from the user. This biometric identifier may include any of a variety of biometric identifier which are unique to a particular individual, such as a retinal scan, or more commonly a finger print. Moreover, the biometric input device associated with the biometric input assembly may include any appropriate input device normally utilized for biometric input, however, for the purposes of the present invention it is seen that a biometrically enabled computer pointer device provides for the most convenient and effective functionality within the contents of the present invention.

The secure computerized network access system 10 of the present invention, and in particular the biometric access system further includes a biometric authentication assembly 26. The biometric authentication assembly is structured to receive and subsequently compare the biometric identifier of the user, as obtained by the biometric input assembly 35, with one, but often a plurality of biometric authentication templates. In particular, the biometric authentication template(s) preferably include biometric data that relates specifically to one or more authorized user's at one or varying security levels. As a result, the biometric authentication assembly 26 utilizes biometric data from the biometric identifier in comparison with the biometric data of the biometric authentication template, such as through the utilization of minutia point comparison and/or an appropriate comparison algorithm, in order to determine the identity of the user and thereby designated the user as an authorized user when appropriate.

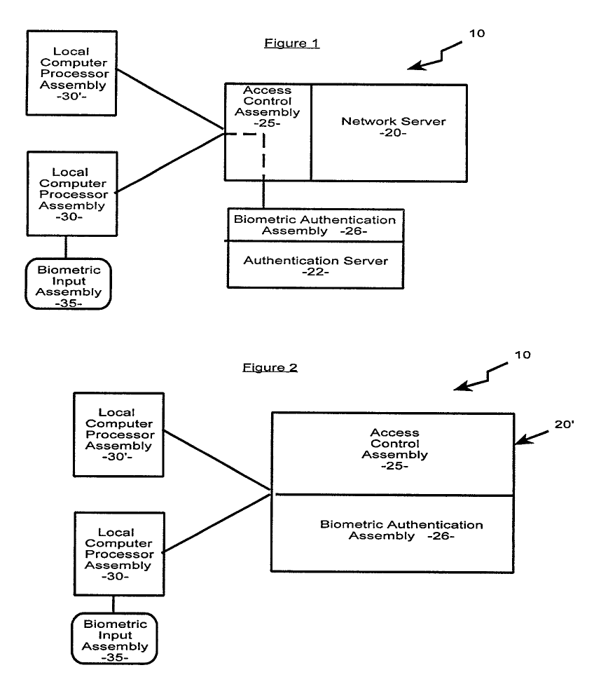

With regard to the biometric authentication assembly 26, although all necessary software, hardware and biometric authentication templates may be directly stored on the biometric input assembly 35 and/or the local computer processor assembly 30 associated therewith, in the illustrated embodiments the biometric authentication assembly is defined at least partially in association with an authentication server 22. In particular, the authentication server 22 preferably stores a plurality of biometric authentication templates thereon and performs the necessary comparison in order to identify a user as an authorized user. Along these lines, and as illustrated in FIG. 1, the separate authentication server 22 may be provided in a substantially isolated manner from the network server 20. Moreover, although it is recognized that a separate, dedicated connection can lead from the biometric input assembly 35 and/or the local computer processor assembly 30 to the authentication server 22 for direct communication of biometric data and other required information, it is also possible that the existing cabling and connectivity already associated with the computerized network will be used. In such an embodiment, the authentication server 22 is isolated from the network server 20, the biometric authentication data and transmissions being communicated directly to the authentication server 22 in a manner that requires little or no access be established with the network server 20 and/or the restricted system resources during the biometric authentication process. Of course, as illustrated in FIG. 2, if desired the biometric authentication assembly 26 and the network access control assembly 25 may both be provided into a single integrated server 20′ which includes both the network server and authentication server. In the embodiment wherein authentication server 22 is isolated, however, a primary advantage relates to the fact that by gaining access to the network server 20 and/or the network system resources, access to the authentication server 22 and confidential biometric data contained thereon is not also readily obtained. Moreover, the system resources are not occupied and/or used by the biometric authentication functionality, thereby minimizing any hindrance on the capacity and/or operating efficiency of the existing network operating system as a result of the biometric authentication system, and providing for facilitated integration of the biometric authentication system in connection with an existing network operating system.

Upon the biometric authentication assembly 26 appropriately verifying that a user is indeed an authorized user, the biometric authentication assembly 26 is further structured to provide a personal access code for the authorized user to the network access control assembly 25. In particular, each biometric authentication template, which includes the appropriate biometric identifier data associated with authorized users, may also include the authorized user's personal access code stored thereon. Because the user is not being required to directly recall and/or memorize the personal access code, the personal access code may be 5, 10, 20, or more characters of any format long, thereby substantially enhancing and increasing the security to be achieved by the network operating system. Along these lines, it is seen that preferably a unique personal access code is provided for each authorized user so as to maximize monitoring and security, however, it is understood that a single personal access code may be provided for multiple or all authorized users based on the high degree of security associated with the particular personal access code and the biometric identification. Such an embodiment, however, would preferably include means to monitor which authorized user gain access of at particular time utilizing the personal access code. Furthermore, if desired a single use personal access code may be provided and may be previously generated and/or generated randomly or from a list upon a user seeking to gain access to the system resources.

As indicated, the personal access code is provided by the biometric authentication assembly 26, thereby eliminating the need for the user to memorize and/or otherwise retain the personalize code for direct, time consuming entry. Along these lines, it is noted that the personal access coded can be provided directly to the network access control assembly 25 so as to achieve internal authentication, and/or may be provided at the local computer processor assembly 30 in a more traditional input environment that may be pre-established by the network operating system. Furthermore, if desired, the biometric authentication assembly 26 may provide only a portion of the personal access code, the user at the local computer processor assembly 30 still being required to enter one or a smaller number of characters which make up the remainder of and/or an additional personal access code. In that manner, the substantially high degree of security associated with a longer personal access code can be achieved, however, user prompting for a further portion of the personal access code is maintained for even further security whereby access to the biometric authentication server 22 does not provide access to an authorized user's entire personal access code. It is also noted that the transmission of the personal access code may be in an encrypted format, decryption being achieved either at the local computer process assembly 30 or by the network access control assembly 25.

From the proceeding it is seen that the present invention further relates to a method of gaining access to restricted systems resources over a computerized network. In particular, the method includes initially obtaining a biometric identifier, such as a finger print from a user seeking to access the restricted system resources. Subsequently, the biometric identifier is compared with at least a part of one biometric authentication template in order to identify the user as an authorized user. Next, a personal identification code, and preferably a unique personal identification code, is identified for the authorized user. Finally, the personal identification code is provided, preferably directly to the network access control assembly, for the authorized user, thereby allowing the existing network operating system to properly process the personal access code and permit access by the authorized user to the restricted system resources.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A secure computerized network access system comprising:
a) at least one local computer processor assembly;
b) at least one network server communicatively associated with said local computer processor assembly;
c) a network access control assembly structured to restrict access to said network server by a user utilizing said local computer processor assembly;
d) said network access control assembly structured to require a personal access code so as to permit said access by the user to said network server;
e) a biometric input assembly structured to receive a biometric identifier from the user;
f) a biometric authentication assembly structured to compare said biometric identifier of the user with at least one biometric authentication template;
g) said biometric authentication assembly structured to identify the user as an authorized user upon said biometric identifier corresponding said biometric authentication template; and
h) said biometric authentication assembly structured to provide said personal access code for said authorized user to said network access control assembly.

2. The secure computerized network access system as recited in claim 1 wherein said biometric identifier includes a fingerprint.

3. The secure computerized network access system as recited in claim 1 wherein said biometric authentication assembly is structured to compare said biometric identifier of the user with a plurality of said biometric authentication templates.

4. The secure computerized network access system as recited in claim 1 wherein said biometric authentication assembly is structured to provide said personal access code directly to said network access control assembly.

5. The secure computerized network access system as recited in claim 4 wherein said personal access code is concealed from the user.

6. The secure computerized network access system as recited in claim 4 wherein said personal access code is securely transmitted to said network access control assembly.

7. The secure computerized network access system as recited in claim 6 said personal access code is transmitted to said network access control assembly in an encrypted format.

8. The secure computerized network access system as recited in claim 1 wherein said personal access code is unique to said authorized user.

9. The secure computerized network access system as recited in claim 1 wherein said personal access code is at least ten characters in length.

10. The secure computerized network access system as recited in claim 1 wherein said personal access code is at least five characters in length.

11. The secure computerized network access system as recited in claim 1 wherein said personal access code is at least twenty characters in length.

12. The secure computerized network access system as recited in claim 1 further comprising an authentication server communicatively associated with said local computer processor assembly, said authentication server structured to store a plurality of said biometric authentication templates.

13. The secure computerized network access system as recited in claim 12 wherein said authentication server is integrated with said network server.

14. The secure computerized network access system as recited in claim 12 wherein said authentication server is isolated from said network server.

15. For use in combination with a network access control assembly of the type requiring a personal identification code to gain access to restricted system resources, a biometric access system comprising:
a) a biometric input assembly structured to receive a biometric identifier from a user desiring access to the restricted system resources;
b) a biometric authentication assembly structured to receive and compare said biometric identifier with at least one biometric authentication template;
c) said biometric authentication assembly further structured to identify an authorized user as a result of said comparison of said biometric identifier with said at least one biometric authentication template; and
d) said biometric authentication assembly structured to provide said personal identification code to the network access control assembly in association with said authorized user.

16. The biometric access system recited in claim 15 wherein biometric identifier includes a fingerprint.

17. The biometric access system recited in claim 15 wherein said biometric authentication assembly includes an authentication server structured to store a plurality of said biometric authentication templates.

18. The biometric access system recited in claim 15 wherein said biometric authentication assembly is structured to communicate said personal identification code directly to the network access control assembly.

19. The biometric access system recited in claim 15 wherein said biometric authentication assembly is structured to provide a unique personal identification code for said authorized user.

20. A method of gaining access to restricted system resources over a computerized network comprising:
a) obtaining a biometric identifier from a user seeking access to the restricted system resources;
b) comparing said biometric identifier with at least part of at least one biometric authentication template in order to identify the user as an authorized user;
c) identifying a personal identification code for said authorized user; and
d) providing said personal identification code for said authorized user to a network access control assembly.

21. The method of gaining access to restricted system resources over a computerized network recited in claim 20 wherein obtaining the biometric identifier further comprises obtaining fingerprint data from the user.

22. The method of gaining access to restricted system resources over a computerized network recited in claim 20 wherein providing said personal identification code for said authorized user to the network access control assembly further comprises providing said personal identification code for said authorized user directly to the network access control assembly.

23. The method of gaining access to restricted system resources over a computerized network recited in claim 20 wherein identifying said personal identification code for said authorized user further comprises identifying a unique personal identification code for said authorized user.
